(19) United States
(12) Patent Application Publication
(10) Pub. No.: US 2024/0005418 A1
(43) Pub. Date: Jan. 4, 2024

(54) CHARGING SERVICE PROVIDING SERVER AND METHOD FOR VEHICLE CHARGING

(71) Applicant: TBU INC., Seoul (KR)

(72) Inventor: Sang Jin PAIK, Seoul (KR)

(73) Assignee: TBU INC., Seoul (KR)

(21) Appl. No.: 18/036,394

(22) PCT Filed: Nov. 12, 2021
(86) PCT No.: PCT/KR2021/016531

§ 371 Date: May 10, 2023

(30) Foreign Application Priority Data
Nov. 12, 2020 (KR) 10-2020-0151119
Nov. 11, 2021 (KR) 10-2021-0155098

(51) Int. Cl. G06Q 50/06; G06Q 10/0631; G07C 5/00

(52) U.S. Cl. CPC G06Q 50/06; G06Q 10/063112; G07C 5/004

(57) ABSTRACT

A charging service providing server for vehicle charging includes a storage, a communication interface unit, a memory, and a processor. The processor of the charging service providing server executes instructions stored in the memory to determine whether a charging service providing condition is satisfied, by using a first charging service providing model that uses, as an input, vehicle information including charging status information and location information of a vehicle, the vehicle information being stored in the storage, when the charging service providing condition is satisfied, determine a charging service providing plan by using a second charging service providing model that uses, as inputs, the vehicle information, charging service status information, and road condition information, transmit information about the determined charging service providing plan to a user terminal corresponding to the vehicle via the communication interface unit, and transmit charging service operation information according to the determined charging service providing plan to a charging service engineer terminal.

### TECHNICAL FIELD

The present disclosure relates to a charging service providing server and method for vehicle charging, and a charging service support application for vehicle charging.

### BACKGROUND ART

The electric vehicle market is rapidly increasing day by day due to the rapidly growing demand for electric vehicles. Nevertheless, electric vehicle charging infrastructure is insufficient, and it is difficult to build charging infrastructure in areas with a high density of multi-family dwellings or areas with many old buildings.

There is a demand for a new type of electric vehicle charging solution to overcome constraints of space required for charger installation and constraints of time required for charging.

### DISCLOSURE

### Technical Problem

There are provided a charging service providing server and method for vehicle charging, and a charging service support application for vehicle charging, in which vehicle charging is performed according to a call from a user in need of vehicle charging.

There are provided a charging service providing server and method for providing a charging service by determining a charging service providing plan for a vehicle that satisfies a charging service providing condition.

### Technical Solution

A charging service providing server for vehicle charging according to a first aspect includes a storage, a communication interface unit, a memory storing instructions, and a processor that executes the instructions to determine whether a charging service providing condition is satisfied, by using a first charging service providing model that uses, as an input, vehicle information including charging status information and location information of a vehicle, the vehicle information being stored in the storage, when the charging service providing condition is satisfied, determine a charging service providing plan, by using a second charging service providing model that uses, as inputs, the vehicle information, charging service status information, and road condition information, transmit information about the determined charging service providing plan to a user terminal corresponding to the vehicle via the communication interface unit, and transmit charging service operation information according to the determined charging service providing plan to a charging service engineer terminal.

A charging service providing method for vehicle charging according to a second aspect includes determining whether a charging service providing condition is satisfied, by using a first charging service providing model that uses, as an input, vehicle information including charging status information and location information of a vehicle, when the charging service providing condition is satisfied, determining a charging service providing plan, by using a second charging service providing model that uses, as inputs, the vehicle information, charging service status information, and road condition information, transmitting information about the determined charging service providing plan to a user terminal corresponding to the vehicle, and transmitting charging service operation information according to the determined charging service providing plan to a charging service engineer terminal.

A computer-readable storage medium according to a third aspect stores a program to be executed on a computer, the program including instructions for determining whether a charging service providing condition is satisfied, by using a first charging service providing model that uses, as an input, vehicle information including charging status information and location information of a vehicle, instructions for determining a charging service providing plan by using a second charging service providing model that uses, as inputs, the vehicle information, charging service status information, and road condition information, when the charging service providing condition is satisfied, instructions for transmitting information about the determined charging service providing plan to a user terminal corresponding to the vehicle, and instructions for transmitting charging service operation information according to the determined charging service providing plan to a charging service engineer terminal.

### DESCRIPTION OF DRAWINGS

FIG. 1 is a diagram for explaining a charging service environment for vehicle charging.

FIG. 2 is a diagram for explaining a configuration and operation of a vehicle.

FIG. 3 is a diagram for explaining a configuration and operation of a user terminal.

FIG. 4 is a diagram for explaining a configuration and operation of a charging service providing server for vehicle charging.

FIG. 5 is a diagram for explaining a process for providing a charging service according to a real-time call.

FIG. 6 is a diagram for explaining a user interface according to execution of a charging service support application for vehicle charging.

FIG. 7 is a diagram for explaining a user interface that changes after a real-time call.

FIG. 8 is a diagram for explaining a user interface that outputs a charging status and charging result screen after charging starts.

FIG. 9 is a diagram for explaining a process for providing a charging service according to a reservation call.

FIG. 10 is a diagram for explaining a user interface in which a reservation call is selected according to execution of a charging service support application for vehicle charging.

FIG. 11 is a diagram for explaining a user interface in which a fast-charging reservation is set according to execution of a charging service support application for vehicle charging.

FIG. 12 is a diagram for explaining a user interface in which a slow-charging reservation is set according to execution of a charging service support application for vehicle charging.

FIG. 13 is a diagram for explaining an example of a user interface in which a daybreak-charging reservation is set according to execution of a charging service support application for vehicle charging.

FIG. 14 is a diagram for explaining another example of a user interface in which a daybreak-charging reservation is set according to execution of a charging service support application for vehicle charging.

FIG. 15 is a flowchart showing a charging service support method for vehicle charging.

FIG. 16 is a flowchart showing a charging service providing method for vehicle charging.

FIG. 17 is a diagram for explaining a process for providing a charging service for vehicle charging, performed by a charging service providing server.

FIG. 18 is a flowchart showing a charging service providing method for vehicle charging, performed by a charging service providing server.

### MODE FOR INVENTION

Hereinafter, various embodiments are described in detail with reference to the drawings. In order to more clearly describe the characteristics of the embodiments, a detailed description of matters widely known to those skilled in the art to which the following embodiments belong will be omitted.

In this specification, when it is described that an element is “connected” to another element, the element may be “directly connected”, but another element may be present between the element and the other element. In addition, when a certain element “includes” another element, this means that other elements may be further included rather than excluding other elements unless otherwise specified.

Furthermore, terms including ordinal numbers such as “first” or “second” used in this specification may be used to describe various elements, but the elements should not be limited by the terms. The above terms are used only to distinguish one element from another element.

The present embodiments relate to a charging service providing server and method for vehicle charging, and a charging service support application for vehicle charging, and detailed descriptions of matters widely known to those skilled in the art to which the following embodiments belong will be omitted.

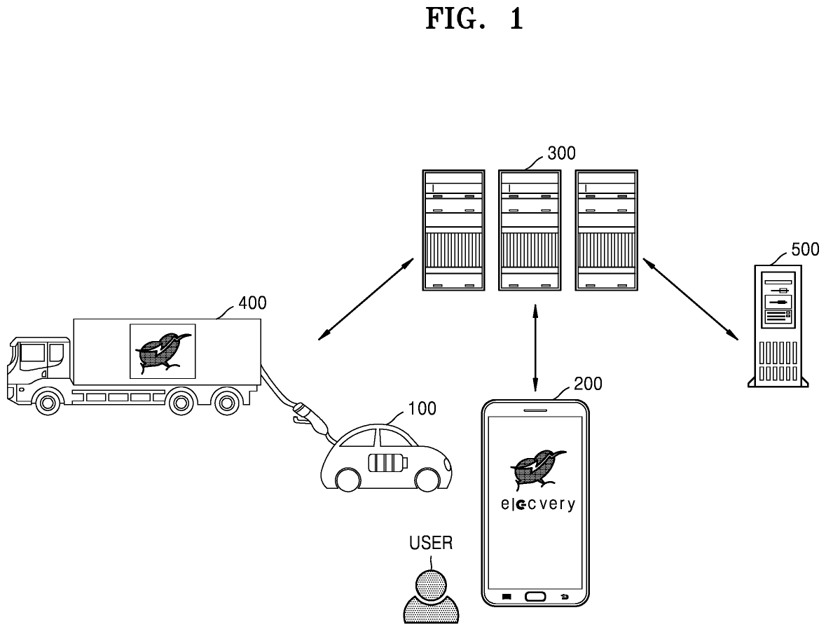

FIG. 1 is a diagram for explaining a charging service environment for vehicle charging.

A vehicle 100 refers to a means of transportation or a means of mobility, each having a rechargeable battery device. For example, the vehicle 100 may be an electric vehicle, a hybrid car, an electric scooter, an electric kick scooter, or an electric two-wheeled vehicle, which may be charged with electricity. The vehicle 100 may operate by appropriately distributing power of the battery device to where power supply is needed within the vehicle 100. When power is supplied from the battery device to each part of the vehicle 100, the battery device is discharged and needs to be charged.

A user terminal 200 is a terminal device of a user who owns or uses the vehicle 100, and may request utilization of a charging service from a charging service providing server 300. The user terminal 200 may transmit charging service call information to the charging service providing server 300, and may receive an analysis result including whether a charging service may be provided from the charging service providing server 300. A user may call a charging service engineer to where the vehicle 100 is located at a desired time and place via a real-time call or a reservation call by using the user terminal 200.

The charging service providing server 300 may provide a charging service for reaching a time and place desired by a user. The charging service providing server 300 may analyze whether a charging service may be provided by using information received from the vehicle 100 or the user terminal 200, and may provide the charging service according to a result of the analyzing. The charging service providing server 300 may be implemented with a technology such as cloud computing. The charging service providing server 300 may store company information of a plurality of charging service providers, and may provide a charging-service-providing virtual machine for the charging service management of each company.

A charging service engineer terminal 400 may receive charging service operation information from the charging service providing server 300. The charging service operation information may include information about a vehicle to be provided with a charging service, charging type information, information about a time to provide a charging service, and charging location information. The charging service engineer terminal 400 may be a terminal device carried by a charging service engineer or may be a terminal device embedded in a means of transportation carrying a charging device. A means of transportation which performs a charging service may include a charging device of a mobile type or may include a charging device of a buried type. A means of transportation which performs a charging service may stand by in a charging station that provides a charging service, or may be placed in a certain area for a certain period of time in the form of a pop-up means of transportation.

An external server 500 may be an e-commerce server of an outsourcing company that provides an additional service. The charging service providing server 300 may itself provide an additional service such as car washing or light maintenance, in addition to a charging service, and may provide an additional service as well as a charging service via partnerships with other companies that provide an additional service. The charging service providing server 300 may be connected to the external server 500 to collect information necessary for providing a charging service or request an additional service from the external server 500.

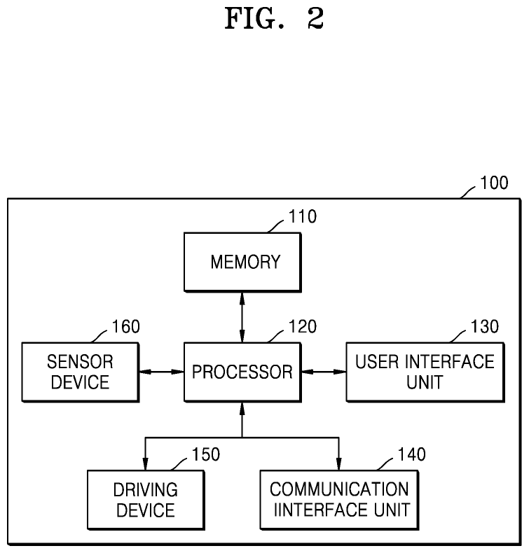

FIG. 2 is a diagram for explaining a configuration and operation of the vehicle 100.

Referring to FIG. 2, the vehicle 100 includes a memory 110, a processor 120, a user interface unit 130, a communication interface unit 140, a driving device 150, and a sensor device 160. Those skilled in the art related to the present embodiment may know that other general-purpose elements may be further included in addition to the elements shown in FIG. 2.

The memory 110 may store software and/or a computer program. The memory 110 may store instructions executable by the processor 120. The processor 120 may access and use data stored in the memory 110, or may store new data in the memory 110. The processor 120 may execute the instructions stored in the memory 110. The processor 120 may include at least one processing module.

The user interface unit 130 may include an input unit that receives an input from a user such as a driver and an output unit that provides information. The input unit may receive various types of inputs from a user, and the output unit may include a display panel and a controller that controls the display panel. The user interface unit 130 may be provided in the form of a touch screen in which the display panel and a touch panel are coupled.

The communication interface unit 140 may perform wired/wireless communication with another device or a network. To this end, the communication interface unit 140 may include a communication module that supports at least one of various wired/wireless communication methods. The communication interface unit 140 may be connected to a device located outside the vehicle 100 to transmit/receive a signal or a message including data.

The driving device 150 may include a brake, an accelerator, a steering device, a battery device, a driving motor, and a transmission. The brake may be a combination of members configured to decelerate the vehicle 100. The accelerator may be a combination of members configured to control the speed of the vehicle 100 by controlling the operating speed of the driving motor. The steering device may be a device used to control the direction of the vehicle 100. The battery device may be a source of energy that provides power to all or part of the driving motor. In other words, the driving motor may be configured to convert electrical energy stored in the battery device into mechanical energy. The battery device may provide electricity to a system and device of the vehicle 100. The driving motor may be an electric motor. When the vehicle 100 is a gas-electric hybrid car, the driving motor may be a gasoline engine and an electric motor. The transmission may be configured to transfer mechanical power from the driving motor to a wheel/tyre.

The sensor device 160 may include a sensor configured to sense information about an environment in which the vehicle 100 is located and one or more actuators configured to modify the location or orientation of sensors. According to an embodiment, the sensor device 160 may include, but is not limited to, at least one of a global positioning system (GPS), a camera, an inertial sensor, an acceleration sensor, a geomagnetic sensor, a temperature sensor, a humidity sensor, a barometric pressure sensor, a distance sensor, a speed sensor, an inertial measurement unit (IMU), a radar device, and a lidar device. The GPS may be a sensor configured to estimate a geographic location of the vehicle 100. The camera may include a plurality of cameras, and the plurality of cameras may be arranged at a plurality of locations on the interior or exterior of the vehicle 100. The IMU may be a combination of at least one sensor configured to sense changes in the location and orientation of the vehicle 100 based on inertial acceleration. The radar device may be a sensor configured to sense objects in an environment in which the vehicle 100 is located by using a radio signal. The lidar unit may be a sensor configured to sense objects in an environment in which the vehicle 100 is located by using a laser. More specifically, the lidar unit may include a laser light source and/or a laser scanner, which is configured to emit a laser beam, and a detector configured to detect a reflection of a laser beam.

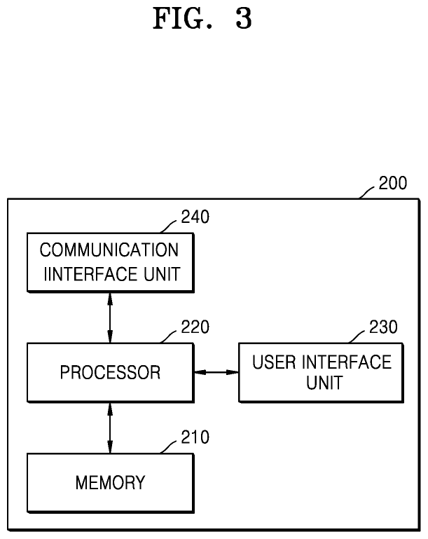

FIG. 3 is a diagram for explaining a configuration and operation of the user terminal 200.

Referring to FIG. 3, the user terminal 200 include a memory 210, a processor 220, a user interface unit 230, and a communication interface unit 240. Those skilled in the art related to the present embodiment may know that other general-purpose elements may be further included in addition to the elements shown in FIG. 3.

The memory 210 may store software and/or a computer program. For example, the memory 210 may store a program such as an application and an application programming interface (API), and various kinds of data. The memory 210 may store instructions executable by the processor 220.

The processor 220 may access and use data stored in the memory 210, or may store new data in the memory 210. The processor 220 may execute the instructions stored in the memory 210. The processor 220 may execute an application installed on the user terminal 200.

The processor 220 may include at least one processing module. The processor 220 may control other elements included in the user terminal 200 to perform an operation corresponding to a result of executing an instruction or a computer program.

The user interface unit 230 may include an input unit that receives an input from a user and an output unit that provides information. The input unit may receive various types of inputs from a user, and may include at least one of a keypad, a touch panel, and a pen recognition panel. The output unit may include a display panel and a controller that controls the display panel, and may be implemented in various ways, such as a liquid crystal display (LCD), an organic light-emitting diode (OLED) display, an active-matrix organic light-emitting diode (AM-OLED), and a plasma display panel (PDP). The display panel may be implemented to be flexible or wearable. The user interface unit 230 may be provided in the form of a touch screen in which the display panel and a touch panel are coupled.

The communication interface unit 240 may perform wired/wireless communication with another device or a network. To this end, the communication interface unit 240 may include a communication module that supports at least one of various wired/wireless communication methods. For example, a communication module that performs various types of mobile communication or ultra-wideband communication such as near-field communication such as wireless fidelity (Wi-Fi) and Bluetooth, 3rd generation (3G), fourth generation (4G), and fifth generation (5G) may be included. The communication interface unit 240 may be connected to a device located outside the user terminal 200 to transmit/receive a signal or a message including data.

The processor 220 may execute the instructions stored in the memory 210 to perform the following operation.

The processor 220 may receive an input to a user interface of charging service call information according to execution of a charging service support application, and may transmit the charging service call information to the charging service providing server 300. For example, the processor 220 may automatically receive an input to the user interface of vehicle information including charging status information of a vehicle and vehicle identification information by receiving the vehicle information via communication with the vehicle 100, and may manually receive an input to the user interface of user selection information including call type information and charging location information. The charging status information may include information about total charging capacity of a battery device and information about currently remaining charging capacity.

The processor 220 may receive, from the charging service providing server 300, an analysis result of analyzing whether a charging service may be provided, based on charging service call information and charging service status information stored in the charging service providing server 300, in response to the transmission of the charging service call information via the communication interface unit 240. The processor 220 may change and output the user interface based on the received analysis result.

According to an example, the processor 220 may receive inputs to a user interface of vehicle information including charging status information of the vehicle 100 and vehicle identification information, and user selection information including charging location information and real-time call information including charging type information. After the user terminal 200 transmits/receives information via communication with the charging service providing server 300, the processor 220 may output, to the changed user interface, arrival time information and location information of a charging service engineer and estimated charging time information.

According to an example, the processor 220 may receive inputs to a user interface of vehicle information including charging status information of a vehicle and vehicle identification information and user selection information including reservation call information and charging location information. In this case, the reservation call information may include charging type information and reservation time information. After the user terminal 200 transmits/receives information via communication with the charging service providing server 300, the processor 220 may output, to the changed user interface, reservation result information and estimated charging time information according to charging status information of the vehicle 100 and charging type information.

According to an example, the processor 220 may receive an input for vehicle control authority, including a sharing period and sharing function of a digital key, via a digital key sharing authority setting of the vehicle 100, after receiving a notification of arrival of a charging service engineer or receiving reservation result information. A user may set the sharing period and sharing function of the digital key by considering estimated charging time information and an additional service. The processor 220 may transmit the vehicle control authority to the charging service providing server 300. Afterwards, the charging service providing server 300 may transfer the vehicle control authority to the charging service engineer terminal 400, or may store the vehicle control authority and transmit the vehicle control authority to the charging service engineer terminal 400 upon request from the charging service engineer terminal 400.

According to an example, when a charging service is provided to the vehicle 100, the processor 220 may receive a charging status and a charging result from the charging service providing server 300 and output a user interface in which the received charging status and charging result are reflected. Accordingly, a user may check in real time via the user terminal 200 whether the charging service is properly performed, and may check whether the charging service is completed.

Meanwhile, a plurality of users registered in a predetermined charging service coverage area may sign up for a subscription service in which an allocated charging amount is shared for a certain period of time. The processor 220 of the user terminal 200 may provide a user interface so that a user may sign up for a subscription service. After the subscription to the subscription service, when a charging service is requested from the charging service providing server 300, the processor 220 may transmit charging service call information that further includes member management information of the subscription service.

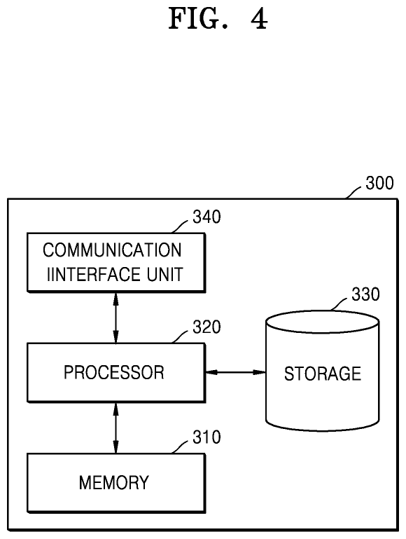

FIG. 4 is a diagram for explaining a configuration and operation of the charging service providing server 300 for vehicle charging.

Referring to FIG. 4, the charging service providing server 300 may include a memory 310, a processor 320, a storage 330, and a communication interface unit 340. Those skilled in the art related to the present embodiment may know that other general-purpose elements may be further included in addition to the elements shown in FIG. 4.

Each element of the block diagram of FIG. 4 may be separated, added, or omitted according to an implementation method of the charging service providing server 300. In other words, according to an implementation method, one element may be subdivided into two or more elements, two or more elements may be combined into one element, or some elements may be added or removed.

The memory 310 may store instructions executable by the processor 320. The memory 310 may store software and/or a program.

The processor 320 may execute the instructions stored in the memory 310. The processor 320 may perform overall control of the charging service providing server 300. The processor 320 may obtain information and requests received via the communication interface unit 340, and may store the received information in the storage 330. In addition, the processor 320 may process the received information. For example, the processor 320 may obtain information used to provide a charging service from information received from the user terminal 200, or may perform a processing operation for managing received information and store the processed information in the storage 330. In addition, the processor 320 may transmit information for providing a charging service to the user terminal 200, the charging service engineer terminal 400, and the external server 500 via the communication interface unit 340 by using data or information stored in the storage 330, in response to a request obtained from the user terminal 200.

The storage 330 may store various software and information necessary for the charging service providing server 300 to provide a charging service. For example, the storage 330 may store programs or applications, which are executed by the charging service providing server 300, and various pieces of data or information used for the charging service.

The storage 330 may compile information for charging service management for the vehicle 100 or each user into a database for storage and management. For example, the storage 330 may store vehicle use pattern information and charging pattern information of a user in correspondence with vehicle identification information. As such, information stored in the storage 330 may be converted into big data and used to predict information used to manage the vehicle 100 via various types of algorithms, mathematical models, or statistical models. For example, the processor 320 may estimate the degree of deterioration of a battery device based on a charging service log file stored in the storage 330 and analyze a charging pattern. The processor 320 may predict the lifespan of the battery device by applying the degree of deterioration of the battery device and the charging pattern to a battery lifespan prediction model.

The communication interface unit 340 may perform communication with an external device such as the vehicle 100, the user terminal 200, the charging service engineer terminal 400, and the external server 500. For example, the charging service providing server 300 may receive a charging service request or preset information for preparing a charging service environment from the user terminal 200, and may provide information related to a charging service in response to a request from an external device.

The charging service providing server 300 may include a load balancing server and functional servers that provide a charging service. For example, the functional servers may be a charging service reception server, a charging service status information management server, and a charging service analysis server. The charging service providing server 300 may include a plurality of servers divided according to functions or may be an integrated server.

The processor 320 may execute the instructions stored in the memory 310 to perform the following operation.

According to an example, the processor 320 may receive charging service call information from an external device via the communication interface unit 340. The external device may be the vehicle 100 or the user terminal 200. The charging service call information may include vehicle information including charging status information of the vehicle 100 and vehicle identification information and user selection information including call type information and charging location information.

According to an example, the processor 320 may analyze whether a charging service may be provided, based on the charging service call information received from the external device and charging service status information stored in the storage 330. The charging service status information may include call-status information which had been received, charging service engineer status information, and charging device status information.

According to an example, the processor 320 may determine an optimal charging service providing plan based on charging status information of the vehicle 100, charging history information corresponding to vehicle identification information, call type information, charging location information, and charging service status information.

According to an example, when the call type information received from the external device is real-time call information including charging type information, an analysis result may include arrival time information and location information of a charging service engineer and estimated charging time information. According to another example, when the call type information received from the external device is reservation call information including charging type information and reservation time information, an analysis result may include reservation result information and estimated charging time information.

According to an example, the processor 320 may transmit the analysis result to the external device via the communication interface unit 340, and may transmit charging service operation information to the charging service engineer terminal 400 according to the analysis result.

According to an example, the processor 320 may store a charging service log file corresponding to the vehicle 100 in the storage 330 whenever a charging service is provided to the vehicle 100, and may analyze a battery state of the vehicle 100 based on the stored charging service log file. The processor 320 may transmit the analyzed battery state to the external device when the analyzed battery state is less than a predetermined charging state or greater than or equal to a predetermined degree of deterioration.

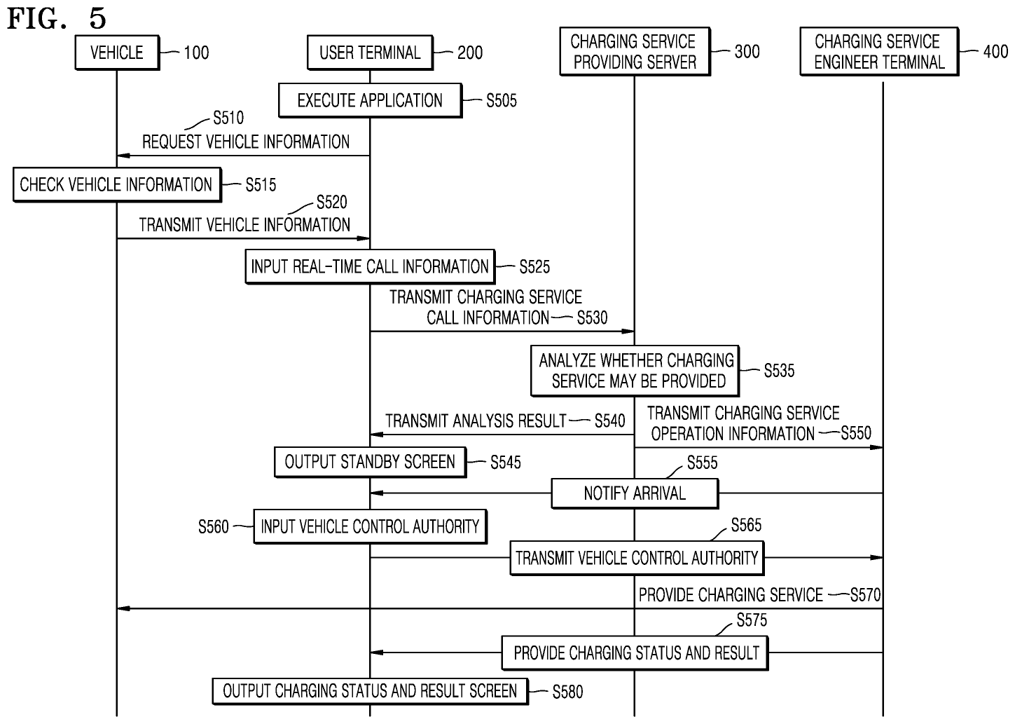

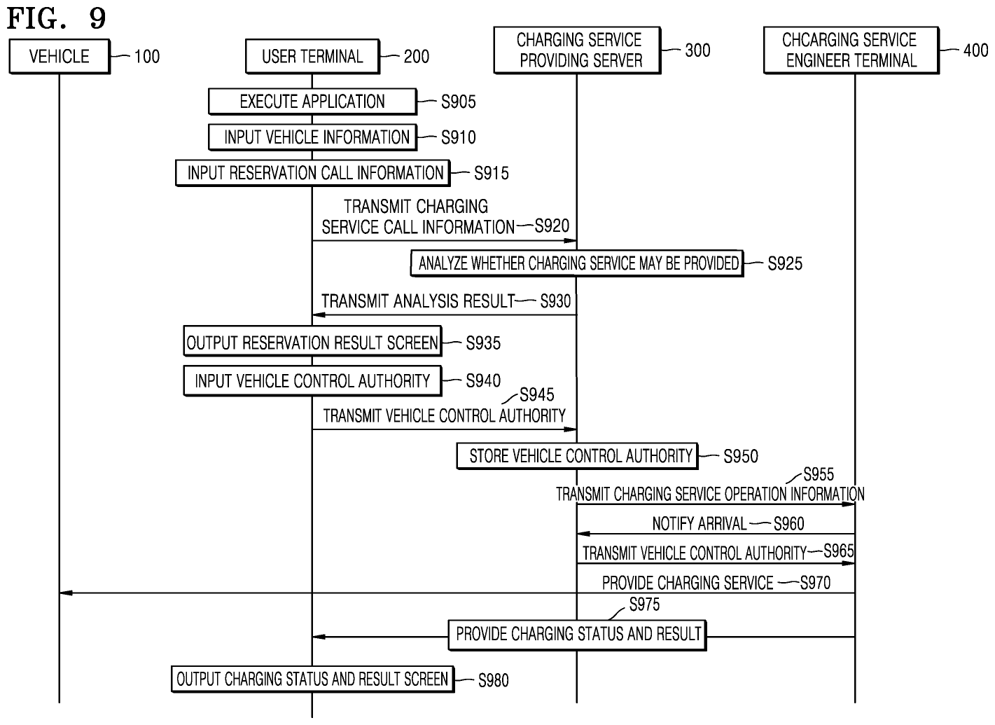

FIG. 5 is a diagram for explaining a process for providing a charging service according to a real-time call. A charging service may be provided according to a real-time call or a reservation call. FIG. 5 illustrates an example in which a charging service is provided according to a real-time call, and FIG. 9 illustrates an example in which a charging service is provided according to a reservation call.

The user terminal 200 may execute a charging service support application (S505). The charging service support application may be installed in the user terminal 200 or the vehicle 100, but for convenience of explanation, as shown in FIG. 5, description is made assuming that the charging service support application is installed in the user terminal 200. When a user needs to charge the vehicle 100, the user may execute the charging service support application installed in the user terminal 200.

The user terminal 200 may request vehicle information from the vehicle 100 (S510). When a communication connection between the vehicle 100 and the user terminal 200 is possible, the user terminal 200 may automatically request vehicle information from the vehicle 100, upon the charging service support application being executed, to obtain latest vehicle information. However, when a communication connection between the vehicle 100 and the user terminal 200 is impossible, unlike in FIG. 5, the user may manually input vehicle information to the user terminal 200 in person.

The vehicle 100 may check the vehicle information (S515). The vehicle information may include charging status information and vehicle identification information.

The vehicle 100 may transmit the vehicle information to the user terminal 200 (S520). The user terminal 200 may update the vehicle information by receiving current charging status information of the vehicle 100 from the vehicle 100.

The user terminal 200 may receive an input of real-time call information (S525). The real-time call information may include charging type information, and the charging type information of either fast charging or slow charging may be selected by a user. The user terminal 200 may receive inputs to a user interface of charging location information as well as the real-time call information as user selection information. A user may select the real-time call information as call type information, and may select the charging location information by specifying a location on a map or inputting an address. As the charging location information, a current location estimated via a GPS of the user terminal 200 may be input to the user interface and may be determined by adjusting details of a location by the user.

The user terminal 200 may transmit charging service call information to the charging service providing server 300 (S530). The charging service call information may include vehicle information and user selection information. The charging service providing server 300 may receive the charging service call information from the user terminal 200.

The charging service providing server 300 may analyze whether a charging service may be provided, based on the charging service call information and charging service status information stored in the charging service providing server 300 (S535). The charging service status information may be information about how many calls have been received or may be received for each time window, whether there are available charging service engineers and means of transportation that carries a battery device, and the type and number of available charging devices. The charging service providing server 300 may analyze whether a charging service may be provided with respect to a real-time call, and may generate analysis result information to be transmitted to the user terminal 200 and charging service operation information to be transmitted to the charging service engineer terminal 400.

The charging service providing server 300 may transmit, to the user terminal 200, an analysis result of analyzing whether the charging service may be provided (S540). The user terminal 200 may receive, from the charging service providing server 300, the analysis result of analyzing whether the charging service may be provided.

The user terminal 200 may output a standby screen based on the analysis result received from the charging service providing server 300 (S545). For example, the user terminal 200 may output arrival time information and location information of a charging service engineer and estimated charging time information to a user interface of the standby screen.

The charging service providing server 300 may transmit charging service operation information to the charging service engineer terminal 400 (S550). Accordingly, a charging service engineer may identify information about a vehicle to be provided with a charging service, charging type information, information about a time to provide a charging service, and charging location information. In the case of a real-time call, a charging service engineer may prepare a mobile charging device according to a charging type, go to a location according to the charging location information, and find a vehicle to be charged in order to perform an assigned charging service operation.

When receiving an arrival notification from the charging service engineer terminal 400, the charging service providing server 300 may transfer the arrival notification to the user terminal 200 (S555).

After receiving the notification of arrival of a charging service engineer, the user terminal 200 may receive an input for vehicle control authority, including a sharing period and sharing function of a digital key, via a digital key sharing authority setting of the vehicle 100 (S560). A user may set the sharing period and sharing function of the digital key by considering estimated charging time information and an additional service. The digital key sharing authority setting may be preset, and a user who doesn't want to share a digital key may go to the vehicle 100 and meet with a charging service engineer.

When receiving the vehicle control authority, that is, the shared digital key, from the user terminal 200, the charging service providing server 300 may transfer the shared digital key to the charging service engineer terminal 400 (S565).

The charging service engineer may provide a charging service to the vehicle 100. To this end, the charging service engineer terminal 400 may open a door or fuel filler port of the vehicle 100 by using the shared digital key (S570).

When receiving a charging status and result from the charging service engineer terminal 400, the charging service providing server 300 may transfer the charging status and result to the user terminal 200 (S575). The user terminal 200 may receive the charging status and the charging result from the charging service providing server 300.

The user terminal 200 may output a user interface in which the charging status and the charging result are reflected (S580). A user may check in real time via the user terminal 200 whether the charging service is properly performed, and may check whether the charging service is completed. Accordingly, a fee for the charging service may be paid according to a payment method (for example, electronic payment, credit card payment, or payment by deducting a subscription fee) pre-registered by the user.

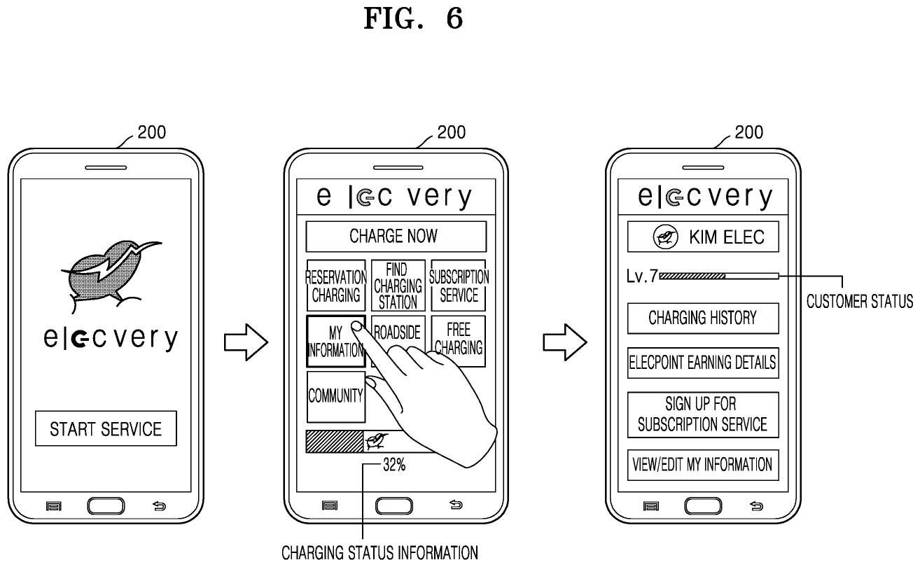

FIG. 6 is a diagram for explaining a user interface according to execution of a charging service support application for vehicle charging.

The charging service support application may be provided in the form of a mobile application or a web application so that non-face-to-face service application and a non-face-to-face charging service may be provided. The charging service support application may be installed in the vehicle 100 or the user terminal 200, and hereinafter, for convenience of explanation, description is made assuming that the charging service support application is in the form of a mobile application installed in the user terminal 200.

Various types of user interfaces shown in the present disclosure are merely examples for convenience of explanation, and a user interface may be implemented in various designs by changing the configuration or style of a screen to receive an input of a user with respect to various pieces of information on one screen or to continuously receive an input of a user via screens that are sequentially provided.

Referring to FIG. 6, the user terminal 200 may output a start screen when the charging service support application is executed, and may output an application home screen when a “START SERVICE” button is input from a user. The home screen may include a “CHARGE NOW” button for a real-time call and a “RESERVATION CHARGING” button for a reservation call. In addition, the home screen may further include, but is not limited to, buttons such as “FIND CHARGING STATION”, “SUBSCRIPTION SERVICE”, “MY INFORMATION”, “ROADSIDE ASSISTANCE”, “FREE CHARGING”, “COMMUNITY”, “CUSTOMER SERVICE CENTER”, and “SETTINGS”, and may display charging status information of the vehicle 100, and a user interface of the home screen may be changed in terms of components or display methods.

“FIND CHARGING STATION” is a menu that informs the location of a charging station equipped with a charging device. When the “FIND CHARGING STATION” button is input to the home screen, a function screen of a user interface in which the location of a charging station may be displayed or a charging station under a specific condition may be retrieved may be provided. For example, a user may set at least one condition in the corresponding user interface, such as a charging station with the shortest waiting time, a charging station with the lowest charging cost, and a charging station with a fast-charging device, to check the location of a charging station that fully satisfies the corresponding condition. A charging station may be a pop-up charging station (pop-up station), and the pop-up charging station refers to a place where a mobile charging device may be installed at a certain place for a certain period of time to temporarily provide a charging service.

“SUBSCRIPTION SERVICE” is a charging service membership menu that allows a charging service to be provided for a certain period of time. The charging service providing server 300 may provide an additional service or a benefit service or may provide a user-customized charging service by using member management information of a user who signs up for a subscription service. For example, a plurality of users registered in a predetermined charging service coverage area may sign up for a subscription service in which an allocated charging amount is shared for a certain period of time. Users may sign up for a subscription service and pay a predetermined subscription fee, and may use the subscription service in such a manner that a service fee corresponding to the service is deducted from the paid subscription fee when the subscription service including a charging service is used.

“MY INFORMATION” is a menu for checking details of usage related to a charging service or setting member management information used for member management of a charging service.

“ROADSIDE ASSISTANCE” is a menu for quickly dispatching a service engineer according to roadside assistance call information of a user. When the “ROADSIDE ASSISTANCE” button is input to the home screen, a function screen of a user interface in which a reason for roadside assistance and roadside assistance location may be input may be provided. Accordingly, a service engineer designated by a charging service provider or an insurance company to which a user subscribes may dispatch to the spot.

“FREE CHARGING” is a menu that guides or links a user to a service that a user needs to use to get a charging service for free or to a service from an affiliated or related company. “COMMUNITY” is a menu that allows access to space on the Internet that is available to users of a charging service. “CUSTOMER SERVICE CENTER” is a menu in which Q&A or complaints related to a charging service may be received. “SETTINGS” is a menu for setting a usage environment of a charging service support application or setting basic information required to use a charging service.

When a specific button is input to the home screen, it may move from the home screen to a function screen corresponding to the corresponding button in order to perform a function of the corresponding button. For example, as shown in FIG. 6, when the “MY INFORMATION” button is input, a function screen including buttons such as “CUSTOMER LEVEL”, “CHARGING HISTORY”, “POINT EARNING DETAILS”, “SIGN UP FOR SUBSCRIPTION SERVICE”, and “VIEW/EDIT MY INFORMATION” may be output.

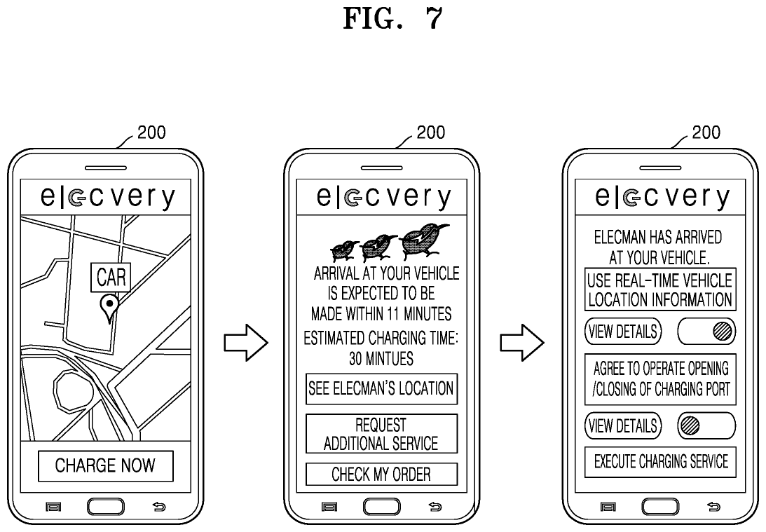

FIG. 7 is a diagram for explaining a user interface that is changed after a real-time call.

Referring to FIG. 7, after the “CHARGE NOW” button for a real-time call is input to the home screen, an image of a user interface in which a screen immediately before charging location information is selected and charging service call information is transmitted is converted into a standby screen and then changed to a charging service engineer arrival notification screen is shown.

The user terminal 200 may output arrival time information and location information of a charging service engineer and estimated charging time information to a user interface of the standby screen. In addition, the user interface of the standby screen may further include, but is not limited to, buttons such as “REQUEST ADDITIONAL SERVICE” and “CHECK MY ORDER”. The user interface of the charging service engineer arrival notification screen may further include, but is not limited to, an operation menu by which operations “SET USE OF REAL-TIME VEHICLE LOCATION INFORMATION” and “AGREE TO OPERATE OPENING/CLOSING OF CHARGING PORT” may be performed.

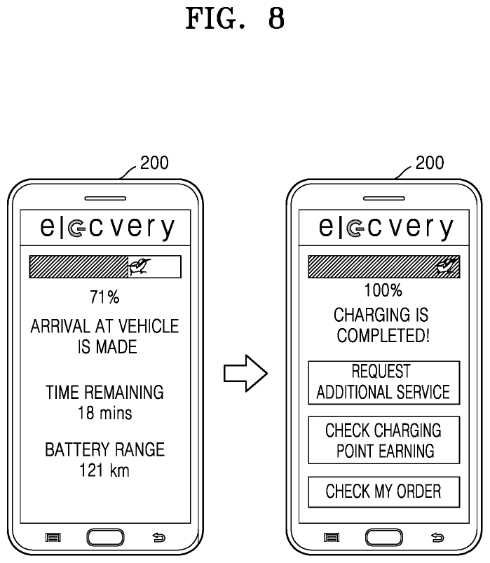

FIG. 8 is a diagram for explaining a user interface that outputs a charging status and charging result screen after charging starts.

The user terminal 200 may output a user interface in which a charging status and a charging result are reflected. While a charging service is provided to the vehicle 100, a user interface in which a charging status, such as current charging status information and a remaining time to complete a charging service, is reflected may be output. When charging is completed, a user interface in which final charging status information is reflected may be output, and the user interface may further include buttons such as “REQUEST ADDITIONAL SERVICE”, “CHECK CHARGING POINT EARNING”, and “CHECK MY ORDER”.

FIG. 9 is a diagram for explaining a process for providing a charging service according to a reservation call. Descriptions that are already given with reference to FIG. 5 are omitted.

The user terminal 200 may execute a charging service support application (S905).

The user terminal 200 may receive an input of vehicle information (S910). When a communication connection between the vehicle 100 and the user terminal 200 is impossible, a user may manually input vehicle information to the user terminal 200 in person. Unlike in FIG. 9, when a communication connection between the vehicle 100 and the user terminal 200 is possible, the user terminal 200 may receive vehicle information from the vehicle 100.

The user terminal 200 may receive an input of reservation call information (S915). The reservation call information may include charging type information and reservation time information. A user may select charging type information of any one of fast charging, slow charging, and daybreak charging, and may select a reservation time for charging with a selected charging type. The user terminal 200 may receive inputs to a user interface of charging location information as well as the reservation call information as user selection information. The user may select the reservation call information as call type information, and may select the charging location information.

The user terminal 200 may transmit charging service call information to the charging service providing server 300 (S920). The charging service call information may include vehicle information and user selection information. The charging service providing server 300 may receive the charging service call information from the user terminal 200.

The charging service providing server 300 may analyze whether a charging service may be provided, based on the charging service call information and charging service status information stored in the charging service providing server 300 (S925). The charging service providing server 300 may analyze whether a charging service may be provided with respect to a reservation call, and may generate analysis result information to be transmitted to the user terminal 200 and charging service operation information to be transmitted to the charging service engineer terminal 400.

The charging service providing server 300 may transmit, to the user terminal 200, an analysis result of analyzing whether the charging service may be provided (S930). The user terminal 200 may receive, from the charging service providing server 300, the analysis result of analyzing whether the charging service may be provided.

The user terminal 200 may output a reservation result screen based on the analysis result received from the charging service providing server 300 (S935). For example, the user terminal 200 may output reservation result information and estimated charging time information to a user interface of the reservation result screen.

After outputting the reservation result screen, the user terminal 200 may receive an input for vehicle control authority, including a sharing period and sharing function of a digital key, via a digital key sharing authority setting of the vehicle 100 (S940). For example, when a user selects a daybreak charging as a charging type, selects “OCTOBER 1, 03:00-05:00” as a reservation time, and selects an indoor car wash as an additional service, the user may set “OCTOBER 1, 02:30-05:30” as a sharing period of a digital key and may set “DOOR OPEN” as a sharing function. Unlike a real-time call, in the case of a reservation call, since arrival of a charging service engineer may not be checked at a corresponding reservation time, a user may share a digital key in advance after checking a reservation result screen. However, a user who doesn't want to share a digital key may go to the vehicle 100 and meet with a charging service engineer at a reservation time.

The user terminal 200 may transfer the vehicle control authority, that is, the shared digital key, to the charging service providing server 300 (S945).

The charging service providing server 300 may store the vehicle control authority, that is, the shared digital key, in the storage 330 in correspondence with the vehicle 100 (S950).

The charging service providing server 300 may transmit the charging service operation information to the charging service engineer terminal 400 (S955). Accordingly, a charging service engineer may prepare a mobile charging device according to a charging type, go to a location according to the charging location information at a reservation time, and find a vehicle to be charged, in order to perform an assigned charging service operation.

The charging service engineer terminal 400 may transmit an arrival notification to the charging service providing server 300 (S960).

When receiving the arrival notification from the charging service engineer terminal 400, the charging service providing server 300 may transmit the vehicle control authority, that is, the shared digital key (S965). For example, the charging service engineer terminal 400 may transmit an arrival notification message including vehicle identification information to the charging service providing server 300, and the charging service providing server 300 may retrieve a shared digital key corresponding to the corresponding vehicle identification information from the storage 330 and transmit the shared digital key to the charging service engineer terminal 400.

The charging service engineer may provide a charging service to the vehicle 100. To this end, the charging service engineer terminal 400 may open a door or fuel filler port of the vehicle 100 by using the shared digital key (S970).

When receiving a charging status and result from the charging service engineer terminal 400, the charging service providing server 300 may transfer the charging status and result to the user terminal 200 (S975). The user terminal 200 may output a user interface in which the charging status and the charging result are reflected (S980). Accordingly, a fee for the charging service may be paid according to a payment method (for example, electronic payment, credit card payment, or payment by deducting a subscription fee) pre-registered by a user. However, according to the user's settings, the user terminal 200 may not receive the charging status and result in real time, and may output the charging result when the user requests confirmation via the application.

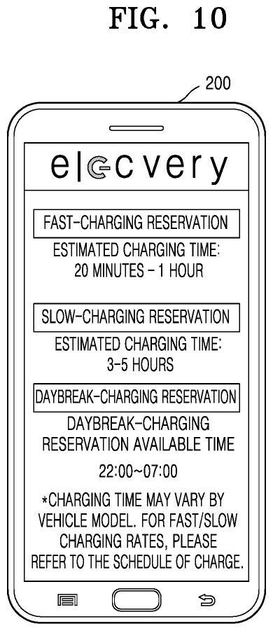

FIG. 10 is a diagram for explaining a user interface in which a reservation call is selected according to execution of a charging service support application for vehicle charging.

Referring to FIG. 10, when the “RESERVATION CHARGING” button for a reservation call is input to the home screen, a user interface of a function screen corresponding to reservation charging may be checked. The user terminal 200 may output a user interface including buttons for selecting charging type information of any one of fast charging, slow charging, and daybreak charging. When a button of any one of “FAST-CHARGING RESERVATION”, “SLOW-CHARGING RESERVATION”, AND “DAYBREAK-CHARGING RESERVATION” is selected in the user interface shown in FIG. 10, conversion into a user interface for setting the respective reservations may be made.

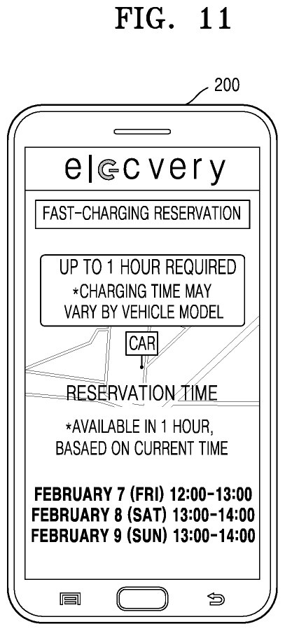

FIG. 11 is a diagram for explaining a user interface in which a fast-charging reservation is set according to execution of a charging service support application for vehicle charging.

Referring to FIG. 11, the user terminal 200 may output a user interface in which a fast-charging reservation is set. Referring to the user interface shown in FIG. 11, estimated time information required for fast charging is displayed, and a menu for setting a reservation time is provided. A user may select a date and time window to reserve fast charging to complete the fast charging reservation.

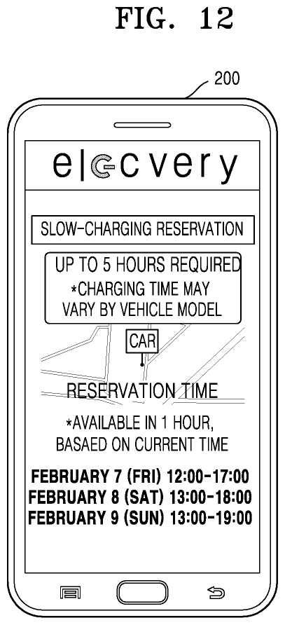

FIG. 12 is a diagram for explaining a user interface in which a slow-charging reservation is set according to execution of a charging service support application for vehicle charging.

Referring to FIG. 12, the user terminal 200 may output a user interface in which a slow-charging reservation is set. Referring to the user interface shown in FIG. 12, estimated time information required for slow charging is displayed, and a menu for setting a reservation time is provided. A user may select a date and time window to reserve slow charging to complete the slow-charging reservation.

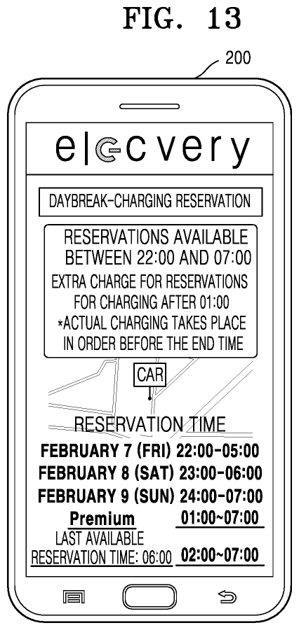

FIG. 13 is a diagram for explaining an example of a user interface in which a daybreak-charging reservation is set according to execution of a charging service support application for vehicle charging.

Referring to FIG. 13, the user terminal 200 may output a user interface in which a daybreak-charging reservation is set. Referring to the user interface shown in FIG. 13, time information corresponding to daybreak charging and precautions are displayed, and a menu for setting a reservation time is provided. A user may specify a date to reserve daybreak charging and a start time and end time to receive daybreak charging, and select to receive daybreak charging at any time window within the time interval, to complete the daybreak-charging reservation.

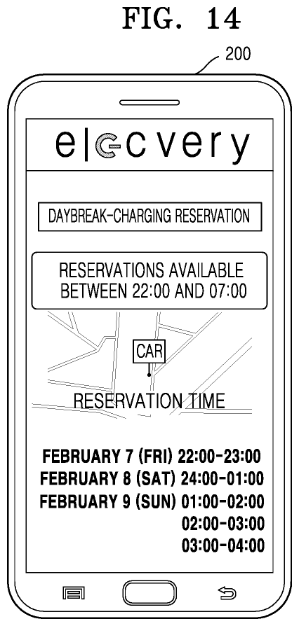

FIG. 14 is a diagram for explaining another example of a user interface in which a daybreak-charging reservation is set according to execution of a charging service support application for vehicle charging.

Referring to FIG. 14, the user terminal 200 may output a user interface in which a daybreak-charging reservation is set. Referring to the user interface shown in FIG. 14, a menu for setting a reservation time is provided. Unlike in FIG. 13, a user may select a date and specific time window to reserve daybreak charging to complete the daybreak-charging reservation.

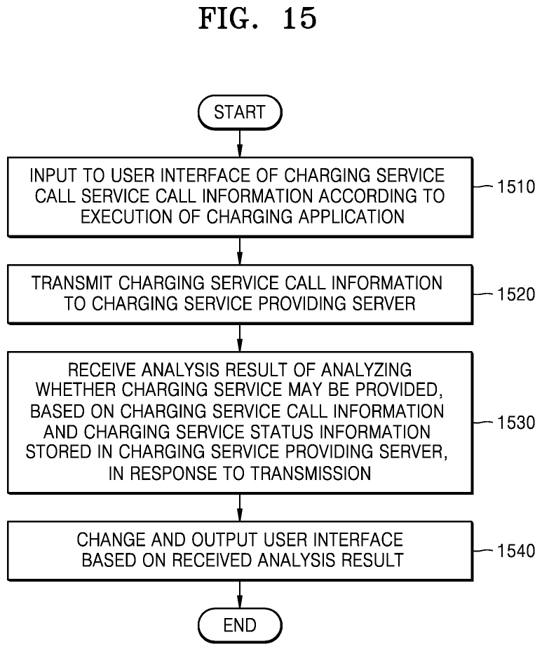

FIG. 15 is a flowchart showing a charging service support method for vehicle charging.

The vehicle 100 or the user terminal 200 may perform a charging service support method for vehicle charging. Terms and descriptions that are already given hereinbefore are omitted hereinafter.

In operation 1510, the vehicle 100 or the user terminal 200 may receive an input to a user interface of charge service call information according to execution of a charging service support application. The charging service call information may include vehicle information including charging status information of a vehicle and vehicle identification information and user selection information including call type information and charging location information. The charging service call information may be manually input by a user, may be automatically input via communication with the vehicle 100, may be preset, or may be automatically input according to history information.

In operation 1520, the vehicle 100 or the user terminal 200 may transmit, to the charging service providing server 300, the charging service call information input to the user interface. In the case of a real-time call, the vehicle 100 or the user terminal 200 may transmit, to the charging service providing server 300, vehicle information including charging status information and vehicle identification information, and user selection information including charging location information and real-time call information including charging type information. In the case of a reservation call, the vehicle 100 or the user terminal 200 may transmit, to the charging service providing server 300, vehicle information including charging status information and vehicle identification information, and user selection information including charging location information and reservation call information including charging type information and reservation time information.

In operation 1530, the vehicle 100 or the user terminal 200 may receive an analysis result of analyzing whether a charging service may be provided, based on the charging service call information and charging service status information stored in the charging service providing server 300, in response to the transmission of the charging service call information.

In operation 1540, the vehicle 100 or the user terminal 200 may change and output a user interface based on the received analysis result. In the case of a real-time call, the vehicle 100 or the user terminal 200 may output, to the changed user interface, arrival time information and location information of a charging service engineer and estimated charging time information. In the case of a reservation call, the vehicle 100 or the user terminal 200 may output, to the changed user interface, reservation result information and estimated charging time information according to charging status information and charging type information of the vehicle 100.

After a charging service request is received by the charging service providing server 300, when the user terminal 200 receives a notification of arrival of a charging service engineer or receives reservation result information, a user may input vehicle control authority, including a shared period and shared function of a digital key, via a digital key sharing authority setting of the vehicle 100. The user terminal 200 may transmit the vehicle control authority to the charging service providing server 300.

When a charging service is provided to the vehicle 100, the user terminal 200 may receive a charging status and a charging result from the charging service providing server 300 and output a user interface in which the received charging status and charging result are reflected.

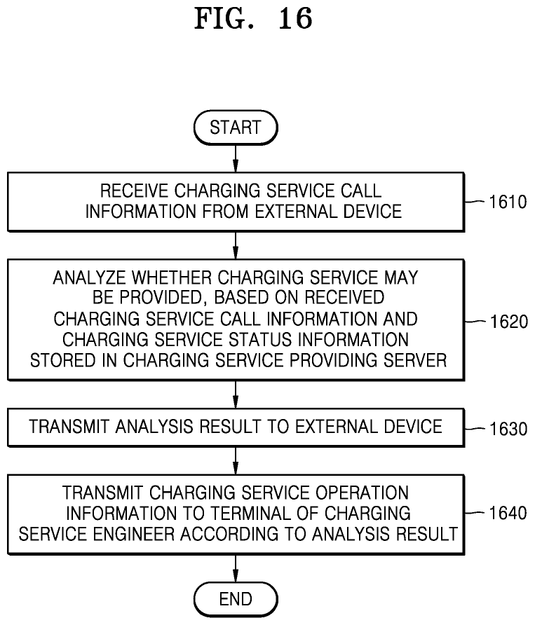

FIG. 16 is a flowchart showing a charging service providing method for vehicle charging.

The charging service providing server 300 may perform a charging service providing method for vehicle charging. Terms and descriptions that are already given hereinbefore are omitted hereinafter.

In operation 1610, the charging service providing server 300 may receive charging service call information from an external device. The external device may be the vehicle 100 or the user terminal 200. The charging service call information may include vehicle information including charging status information of the vehicle 100 and vehicle identification information and user selection information including call type information and charging location information.

In operation 1620, the charging service providing server 300 may analyze whether a charging service may be provided, based on the received charging service call and charging service status information stored in the charging service providing server 300. The charging service status information may include received-call-status information which had been received, charging service engineer status information, and charging device status information. The charging service providing server 300 may determine an optimal charging service providing plan based on charging status information of the vehicle 100, charging history information corresponding to vehicle identification information, call type information, charging location information, and charging service status information.

In addition, the charging service providing server 300 may store a charging service log file corresponding to the vehicle 100 in the storage 330 whenever a charging service is provided to the vehicle 100, and may analyze a battery state of the vehicle 100 based on the stored charging service log file.

In operation 1630, the charging service providing server 300 may transmit an analysis result to the external device. According to an example, when there is a real-time call from the external device, the analysis result may include arrival time information and location information of a charging service engineer and estimated charging time information. According to another example, when there is a reservation call from the external device, the analysis result may include reservation result information and estimated charging time information.

In addition, the charging service providing server 300 may transmit the analyzed battery state to the external device when the analyzed battery state is less than a predetermined charging state or greater than or equal to a predetermined degree of deterioration.

In operation 1640, the charging service providing server 300 may transmit charging service operation information to the charging service engineer terminal 400 according to the analysis result. The charging service operation information may include information about a vehicle to be provided with a charging service, charging type information, information about a time to provide a charging service, and charging location information. A charging service engineer may arrive at a charging location at a time to provide a charging service, and perform electric charging, according to a charging type, on a vehicle to be provided with the charging service, based on the charging service operation information.

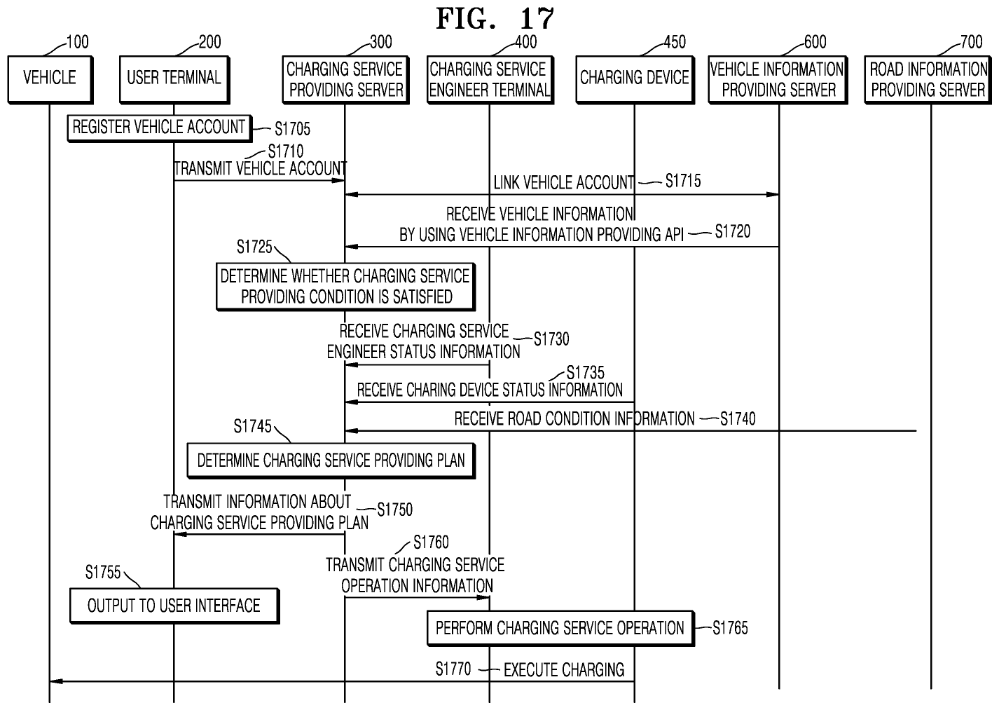

FIG. 17 is a diagram for explaining a process for providing a charging service for vehicle charging, performed by the charging service providing server 300.

A vehicle information providing server 600 such as a vehicle manufacturer server may record vehicle information of the vehicle 100 periodically or whenever vehicle operation is completed. The vehicle information may be charging status information, location information, driving information, vehicle model, or vehicle charging port type information of the vehicle 100, and may be driving pattern information, battery charge/discharge cyclic information, or driving performance information such as electric power consumption, which is identified from vehicle information accumulated while a charging service is used. The charging service providing server 300 may synchronize with the vehicle information providing server 600 and store the vehicle information. Hereinafter, an embodiment, in which the charging service providing server 300 provides a charging service by using one or more charging service providing models without a charging service call of a user, is described.

A charging service providing model may be a prediction model, an analysis model, a statistical model, or an evaluation model, which is based on vehicle information stored in the charging service providing server 300 or various types of situational information. For example, the charging service providing model may be the prediction model that predicts when a battery of the vehicle 100 needs to be charged, or may be the analysis model that analyzes a driving pattern via driving information records of the vehicle 100. The charging service providing model may be the statistical model that calculates statistics based on periodically collected information, or may be the evaluation model that reflects a user's feedback on a charging service.

The user terminal 200 may register a vehicle account of the vehicle 100 in a user interface according to execution of a charging service support application (S1705). A user may execute the charging service support application and input the vehicle account that may be linked to the vehicle information providing server 600.

The user terminal 200 may transmit the registered vehicle account to the charging service providing server 300 (S1710). The charging service providing server 300 may receive, from the user terminal 200, the vehicle account registered by the user.

The charging service providing server 300 may link the vehicle account to the vehicle information providing server 600 (S1715). To this end, the charging service providing server 300 may request the vehicle information providing server 600 to check whether the linkage of the vehicle account is valid, and the vehicle information providing server 600 may check whether the linkage of the vehicle account is valid. When the vehicle account transmitted by the charging service providing server 300 and the vehicle account registered in the vehicle information providing server 600 match, the validity of the vehicle account may be recognized. The charging service providing server 300 may encrypt and store the linked vehicle account.

The charging service providing server 300 may receive vehicle information by using a vehicle information providing application program interface (API) linked by the vehicle account (S1720). The charging service providing server 300 may periodically receive vehicle information from the vehicle information providing server 600 by using the linked vehicle account. For example, the charging service providing server 300 may periodically request vehicle information from the vehicle information providing server 600, or whenever vehicle information is updated in the vehicle information providing server 600, the updated vehicle information may be transmitted to the charging service providing server 300. The vehicle information stored in the charging service providing server 300 may be synchronized with the vehicle information stored in the vehicle information providing server 600 via the linked vehicle account.

The charging service providing server 300 may determine whether a charging service providing condition is satisfied, by using a first charging service providing model that uses, as an input, the vehicle information including charging status information and location information of the vehicle 100 (S1725). The charging service providing server 300 may determine whether it is necessary to provide the charging service to the vehicle 100, without a charging service call, by using the first charging service providing model.

For example, the processor 320 of the charging service providing server 300 may execute the instructions stored in the memory 310 to determine whether it is necessary to provide a charging service to the vehicle 100 at a location corresponding to the location information of the vehicle 100, by predicting a time point at which it is necessary to provide the charging service to the vehicle 100, when driving is performed according to a driving pattern of the vehicle 100 with the remaining battery capacity of the vehicle 100, by using a charging time point prediction model that uses, as inputs, the charging status information of the vehicle 100, the location information of the vehicle 100, and driving pattern information of the vehicle 100.

As another example, the processor 320 of the charging service providing server 300 may execute the instructions stored in the memory 310 to determine whether it is necessary to provide a charging service to the vehicle 100 at a location corresponding to the location information of the vehicle 100, by predicting a time point at which the remaining battery capacity of the vehicle 100 corresponds to a predetermined standard, when the remaining battery capacity of the vehicle 100 is consumed according to a battery charge/discharge cycle of the vehicle 100, by using a remaining battery capacity prediction model that uses, as inputs, the charging status information of the vehicle 100, the location information of the vehicle 100, and battery charge/discharge cycle information of the vehicle 100.

The charging service providing server 300 may receive charging service status information or road condition information periodically or whenever there is updated situational information, in order to determine whether the charging service may be provided and determine which charging service engineer to assign. The charging service status information may be charging service engineer status information and charging device status information.

The charging service providing server 300 may receive charging service engineer status information from the charging service engineer terminal 400 (S1730). The charging service providing server 300 may receive, from the charging service engineer terminal 400, location information of a charging service engineer or charging service operation status information.

The charging service providing server 300 may receive charging device status information from a charging device 450 (S1735). When the charging device 450 may communicate with the charging service providing server 300, the charging service providing server 300 may receive, from the charging device 450, charging status information including the remaining battery capacity of the charging device 450, charging type information including voltage and current information of the charging device 450, or environment information such as temperature.

The charging service providing server 300 may receive road condition information from a road information providing server 700 (S1740). The charging service providing server 300 may receive, from the road information providing server 700, detailed road information or traffic information of respective roads.

The charging service providing server 300 may determine a charging service providing plan by using a second charging service providing model that uses, as inputs, the vehicle information, the charging service status information, and the road condition information (S1745). When the charging service providing condition is satisfied, the processor 320 of the charging service providing server 300 may execute the instructions stored in the memory 310 to determine the charging service providing plan for allocating an optimal charging service engineer to the vehicle 100, by setting one or more routes to move to a location corresponding to the location information of the vehicle 100, for each charging service engineer, and by applying a charging service engineer allocation model that reflects costs of movement of a charging service engineer and gains of providing a charging service with respect to the one or more routes. The charging service engineer allocation model may calculate a degree of suitability for each charging service engineer, by determining the costs of the movement of the charging service engineer according to detailed road information and traffic information of each road, based on the road condition information of each of roads constituting a route, and by determining the gains of providing the charging service according to charging service engineer status information and charging device status information, based on the charging service status information. In this case, a charging service engineer with the highest suitability may be selected as an optimal charging service engineer to perform a charging service operation on the vehicle 100.

The processor 320 of the charging service providing server 300 may execute the instructions stored in the memory 310 to transmit information about the determined charging service providing plan to the user terminal 200 corresponding to the vehicle 100 via the communication interface unit 340 (S1750). The user terminal 200 may receive the information about the charging service providing plan from the charging service providing server 300.

The user terminal 200 may output, to the user interface, information about the charging service providing plan received from the charging service providing server 300 (S1755). For example, the user terminal 200 may output, to the user interface, arrival time information and location information of a charging service engineer and estimated charging time information in order to notify that a charging service is to be provided. The user may reject the provision of the charging service via the user interface.

The processor 320 of the charging service providing server 300 may execute the instructions stored in the memory 310 to transmit charging service operation information according to the determined charging service providing plan to the charging service engineer terminal 400 via the communication interface unit 340 (S1760). The charging service operation information may include identification information of the vehicle 100, the location information of the vehicle 100, charging demand information of the vehicle 100, and voltage and current setting information of the charging device 450 according to a vehicle model of the vehicle 100.

The charging service engineer may perform a charging service operation by preparing the suitable charging device 450 according to the charging service operation information received by the charging service engineer terminal 400 (S1765).

The charging service engineer may go to charging location corresponding to the location information of the vehicle 100, find the to-be-charged vehicle 100 corresponding to the identification information of the vehicle 100, and charge a battery of the vehicle 100 according to the charging demand information by using the charging device 450 set to the voltage and current setting information according to the vehicle model of the vehicle 100 (S1770).

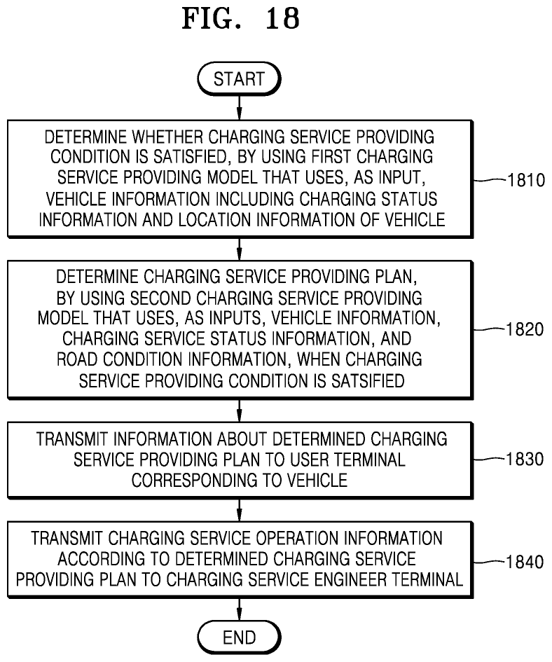

FIG. 18 is a flowchart showing a charging service providing method for vehicle charging, performed by the charging service providing server 300.

Descriptions that are already given hereinbefore are omitted hereinafter.

The charging service providing server 300 may store vehicle information in the charging service providing server 300 by periodically receiving the vehicle information from the vehicle information providing server 600 by using a vehicle information control API linked by a vehicle account registered by a user by using the user terminal 200.

In operation 1810, the charging service providing server 300 may determine whether a charging service providing condition is satisfied, by using a first charging service providing model that uses, as an input, vehicle information including charging status information and location information of the vehicle 100.

For example, when the first charging service providing model is a charging time point prediction model, the charging service providing server 300 may determine whether it is necessary to provide a charging service to the vehicle 100 at a location corresponding to the location information of the vehicle 100, by predicting a time point at which it is necessary to provide the charging service to the vehicle 100, when driving is performed according to a driving pattern of the vehicle 100 with the remaining battery capacity of the vehicle 100, by using the charging time point prediction model that uses, as inputs, the charging status information of the vehicle 100, the location information of the vehicle 100, and driving pattern information of the vehicle 100.

As another example, when the first charging service providing model is a remaining battery capacity prediction model, the charging service providing server 300 may determine whether it is necessary to provide a charging service to the vehicle 100 at a location corresponding to the location information of the vehicle 100, by predicting a time point at which the remaining battery capacity of the vehicle 100 corresponds to a predetermined standard, when the remaining battery capacity of the vehicle 100 is consumed according to a battery charge/discharge cycle of the vehicle 100, by using the remaining battery capacity prediction model that uses, as inputs, the charging status information of the vehicle 100, the location information of the vehicle 100, and battery charge/discharge cycle information of the vehicle 100.

In operation 1820, when the charging service providing condition is satisfied, the charging service providing server 300 may determine a charging service providing plan by using a second charging service providing model that uses, as inputs, the vehicle information, charging service status information, and road condition information.

For example, when the second charging service providing model is a charging service engineer allocation model, the charging service providing server 300 may determine the charging service providing plan for allocating an optimal charging service engineer to the vehicle 100, by setting one or more routes to move to a location corresponding to the location information of the vehicle 100, for each charging service engineer, and by applying the charging service engineer allocation model that reflects costs of movement of a charging service engineer and gains of providing a charging service with respect to the one or more routes.

The charging service engineer allocation model may calculate a degree of suitability for each charging service engineer, by determining the costs of the movement of the charging service engineer according to detailed road information and traffic information of respective roads, based on the road condition information of the respective roads constituting a route, and by determining the gains of providing the charging service according to charging service engineer status information and charging device status information, based on the charging service status information.

In operation 1830, the charging service providing server 300 may transmit information about the determined charging service providing plan to the user terminal 200 corresponding to the vehicle 100. The user terminal 200 may output, to a user interface, the information about the charging service providing plan received from the charging service providing server 300, so that the user of the vehicle 100 may know.

In operation 1840, the charging service providing server 300 may transmit charging service operation information according to the determined charging service providing plan to the charging service engineer terminal 400. The charging service providing server 300 may transmit, to the charging service engineer terminal 400, the charging service operation information including identification information of the vehicle 100, the location information of the vehicle 100, charging demand information of the vehicle 100, and voltage and current setting information of the charging device 450 according to a vehicle model of the vehicle 100, according to the determined charging service providing plan. Accordingly, a charging service engineer may perform a charging service operation, move to the vehicle 100 with the charging device 450 in which voltage and current are set according to the vehicle model of the vehicle 100, and perform charging.

Each of the above-described embodiments may be provided in the form of a computer program or application stored in a medium, in order to execute predetermined operations for performing a charging service providing method for vehicle charging by a server. In addition, each of the above-described embodiments may be provided in the form of a computer program or application stored in a medium, in order to execute predetermined operations for performing a charging service support method for vehicle charging by a terminal device.

In other words, each of the above-described embodiments may be provided in the form of a computer program or application stored in a medium, which allows at least one processor of a server to perform predetermined operations for performing a charging service providing method for vehicle charging. In addition, each of the above-described embodiments may be provided in the form of a computer program or application stored in a medium, which allows at least one processor of a terminal device to perform predetermined operations for performing a charging service support method for vehicle charging.

The above-described embodiments may be implemented in the form of a computer-readable storage medium storing instructions and data executable by a computer or a processor. At least one of the instructions and data may be stored in the form of a program code, and when executed by a processor, may generate a predetermined program module to perform a predetermined operation. The computer-readable storage medium may be read-only memory (ROM), random-access memory (RAM), flash memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, magnetic tape, a floppy disk, a magneto-optical data storage device, an optical data storage device, a hard disk, a solid-state disk (SSD), and any device that may store instructions or software, related data, data files, and data structures and may provide the instructions or software, the related data, the data files, and the data structures to a processor or a computer so that the processor or the computer may execute the instructions.

Hereinbefore, the embodiments are mainly described. Those skilled in the art to which the disclosed embodiments belong will be able to understand that the disclosed embodiments may be implemented in modified forms within a range not departing from essential characteristics. Therefore, the disclosed embodiments should be considered from an illustrative rather than a limiting point of view. The scope of the disclosure is shown in the claims rather than the description of the above-described embodiments, and all differences within the equivalent scope should be construed as being included in the scope of the disclosure.

1. A charging service providing server for vehicle charging, comprising:
a storage;
a communication interface unit;
a memory storing instructions; and
a processor that executes the instructions to determine whether a charging service providing condition is satisfied, by using a first charging service providing model that uses, as an input, vehicle information including charging status information and location information of a vehicle, the vehicle information being stored in the storage, when the charging service providing condition is satisfied, determine a charging service providing plan, by using a second charging service providing model that uses, as inputs, the vehicle information, charging service status information, and road condition information, transmit information about the determined charging service providing plan to a user terminal corresponding to the vehicle via the communication interface unit, and transmit charging service operation information according to the determined charging service providing plan to a charging service engineer terminal.

2. The charging service providing server of claim 1, wherein the first charging service providing model is a charging time point prediction model, and
the processor executes the instructions to determine whether it is necessary to provide a charging service to the vehicle at a location corresponding to the location information of the vehicle, by predicting a time point at which it is necessary to provide the charging service to the vehicle, when driving is performed according to a driving pattern of the vehicle with remaining battery capacity of the vehicle, by using the charging time point prediction model that uses, as inputs, the charging status information of the vehicle, the location information of the vehicle, and driving pattern information of the vehicle.

3. The charging service providing server of claim 1, wherein the first charging service providing model is a remaining battery capacity prediction model, and
the processor executes the instructions to determine whether it is necessary to provide a charging service to the vehicle at a location corresponding to the location information of the vehicle, by predicting a time point at which remaining battery capacity of the vehicle corresponds to a predetermined standard, when the remaining battery capacity of the vehicle is consumed according to a battery charge/discharge cycle of the vehicle, by using the remaining battery capacity prediction model that uses, as inputs, the charging status information of the vehicle, the location information of the vehicle, and battery charge/discharge cycle information of the vehicle.

4. The charging service providing server of claim 1, wherein the second charging service providing model is a charging service engineer allocation model, and
the processor executes the instructions to determine the charging service providing plan for allocating an optimal charging service engineer to the vehicle, by setting one or more routes to move to a location corresponding to the location information of the vehicle, for each charging service engineer, and applying the charging service engineer allocation model that reflects costs of movement of a charging service engineer and gains of providing a charging service with respect to the one or more routes.

5. The charging service providing server of claim 4, wherein the charging service engineer allocation model calculates a degree of suitability for each charging service engineer, by determining the costs of the movement of the charging service engineer according to detailed road information and traffic information of respective roads, based on the road condition information of the respective roads constituting a route, and by determining the gains of providing the charging service according to charging service engineer status information and charging device status information, based on the charging service status information.

6. The charging service providing server of claim 1, wherein the processor executes the instructions to transmit the charging service operation information including identification information of the vehicle, the location information of the vehicle, charging demand information of the vehicle, and voltage and current setting information of a charging device according to a vehicle model of the vehicle, according to the determined charging service providing plan, via the communication interface unit.

7. The charging service providing server of claim 1, wherein the processor executes the instructions to store the vehicle information in the storage by periodically receiving the vehicle information by using a vehicle information providing application program interface (API) linked by a vehicle account registered by a user, via the communication interface unit, and input the vehicle information stored in the storage to the first charging service providing model and the second charging service providing model.

8. A charging service providing method for vehicle charging, performed by a charging service providing server, the charging service providing method comprising:
determining whether a charging service providing condition is satisfied, by using a first charging service providing model that uses, as an input, vehicle information including charging status information and location information of a vehicle;
when the charging service providing condition is satisfied, determining a charging service providing plan, by using a second charging service providing model that uses, as inputs, the vehicle information, charging service status information, and road condition information;
transmitting information about the determined charging service providing plan to a user terminal corresponding to the vehicle; and
transmitting charging service operation information according to the determined charging service providing plan to a charging service engineer terminal.

9. The charging service providing method of claim 8, wherein the first charging service providing model is a charging time point prediction model, and
the determining of whether the charging service providing condition is satisfied comprises determining whether it is necessary to provide a charging service to the vehicle at a location corresponding to the location information of the vehicle, by predicting a time point at which it is necessary to provide the charging service to the vehicle, when driving is performed according to a driving pattern of the vehicle with remaining battery capacity of the vehicle, by using the charging time point prediction model that uses, as inputs, the charging status information of the vehicle, the location information of the vehicle, and driving pattern information of the vehicle.

10. The charging service providing method of claim 8, wherein the first charging service providing model is a remaining battery capacity prediction model, and
the determining of whether the charging service providing condition is satisfied comprises determining whether it is necessary to provide a charging service to the vehicle at a location corresponding to the location information of the vehicle, by predicting a time point at which remaining battery capacity of the vehicle corresponds to a predetermined standard, when the remaining battery capacity of the vehicle is consumed according to a battery charge/discharge cycle of the vehicle, by using the remaining battery capacity prediction model that uses, as inputs, the charging status information of the vehicle, the location information of the vehicle, and battery charge/discharge cycle information of the vehicle.

11. The charging service providing method of claim 8, wherein the second charging service providing model is a charging service engineer allocation model, and
the determining of the charging service providing plan comprises determining the charging service providing plan for allocating an optimal charging service engineer to the vehicle, by setting one or more routes to move to a location corresponding to the location information of the vehicle, for each charging service engineer, and applying the charging service engineer allocation model that reflects costs of movement of a charging service engineer and gains of providing a charging service with respect to the one or more routes.

12. The charging service providing method of claim 11, wherein the charging service engineer allocation model calculates a degree of suitability for each charging service engineer, by determining the costs of the movement of the charging service engineer according to detailed road information and traffic information of respective roads, based on the road condition information of the respective roads constituting a route, and by determining the gains of providing the charging service according to charging service engineer status information and charging device status information, based on the charging service status information.

13. The charging service providing method of claim 8, wherein the transmitting of the charging service operation information to the charging service engineer terminal comprises transmitting the charging service operation information including identification information of the vehicle, the location information of the vehicle, charging demand information of the vehicle, and voltage and current setting information of a charging device according to a vehicle model of the vehicle, according to the determined charging service providing plan.

14. The charging service providing method of claim 8, further comprising storing the vehicle information in the charging service providing server by periodically receiving the vehicle information by using a vehicle information providing application program interface (API) linked by a vehicle account registered by a user,
wherein each of the first charging service providing model and the second charging service providing model uses, as an input, the vehicle information stored in the charging service providing server.

15. A computer-readable storage medium storing a program to be executed on a computer, the program comprising:
instructions for determining whether a charging service providing condition is satisfied, by using a first charging service providing model that uses, as an input, vehicle information including charging status information and location information of a vehicle;
instructions for determining a charging service providing plan by using a second charging service providing model that uses, as inputs, the vehicle information, charging service status information, and road condition information, when the charging service providing condition is satisfied;
instructions for transmitting information about the determined charging service providing plan to a user terminal corresponding to the vehicle; and
instructions for transmitting charging service operation information according to the determined charging service providing plan to a charging service engineer terminal.
